(19) United States
(12) Patent Application Publication
(10) Pub. No.: US 2005/0184680 A1
(43) Pub. Date: Aug. 25, 2005

(54) Methods and apparatus for constructing a power supply capable drawing power from fluorescent lamps

(75) Inventors: Thomas J. Mayer, Wisconsin Dells, WI (US); Peter O. Roach JR., Atlanta, GA (US)

Correspondence Address: PETER O. ROACH JR., 1150 IVES CT., ATLANTA, GA, 30319, US

(73) Assignee: Thomas J. Mayer

(21) Appl. No.: 11/059,269

(22) Filed: Feb. 16, 2005

Related U.S. Application Data
(60) Provisional application No. 60/546,468, filed on Feb. 23, 2004.
(60) Provisional application No. 60/547,574, filed on Feb. 26, 2004.

(51) Int. Cl. H04B 1/04

(52) U.S. Cl. 315/266; 315/278

(57) ABSTRACT

Methods and Apparatus are provided for a power supply capable of being operated directly from fluorescent lighting fixture and capable to functioning properly when supplied by conventional 60 cycles per second (cps) “Core and Coil’ fluorescent lamp power supply (ballasts) as well as ‘Electronic’ or ‘Solid State’ ballasts functioning at frequencies from 20,000 cps to as much as 40,000 cps, without adversely affecting normal lighting fixture operation.

### RELATED APPLICATIONS CLAIMING PRIORITY

The present application claims the benefit of the following two provisional patent applications, which are each incorporated herein by reference: (i) U.S. Provisional Patent Application Ser. No. 60/546,468 entitled “METHODS AND APPARATUS FOR CONSTRUCTING A POWER SUPPLY CAPABLE OF DUAL FREQUENCY INPUT”, filed Feb. 19, 2004; (ii) U.S. Provisional Patent Application Ser. No. 60/547,574 entitled—METHODS AND APPARATUS FOR CONSTRUCTING A DUAL FREQUENCY REGULATED POWER SUPPLY filed Feb. 24, 2003.

### TECHNICAL FIELD

The present invention relates generally to a power supply that derives its voltages from the lamp to fixture interface of a fluorescent light. This power supply is primarily intended to be used in a wired or wireless communications network and more particularly to the use of radio communications networks in a dwelling, commercial building, campus environment, tunnels and/or neighborhoods.

### BACKGROUND OF THE INVENTION

In recent years, wireless communications networks have begun to penetrate into homes, office buildings, business parks, and neighborhoods. Most of these wireless networks are private networks serving a single building or campus. In order to meet current government regulations regulating the use of radio spectrum, a low signal transmit level is often used in these types of environments. This lower transmit level allows the signal to be effectively limited to the desired area by using walls, furniture, other obstructions, or even free space to attenuate the signal and contain it. While a low transmit level works well to contain the signal, it can also have unintended consensuses of allowing gaps in the coverage area where signals may be desired.

As businesses and commercial spaces deploy large wireless local area networks (WLAN) they have begun to realize the complexity of these networks tends to grow as the coverage area expands. This is mainly due to the radio capacity or channels needed to cover an enterprise space. In many wireless LAN technologies there are a limited number of radio channels available from any individual radio transmitter, base station, or access point. This limit is caused primarily by the availability of non-overlapping or non-interfering channels. Typically the number of channels is limited by bandwidth, regulations, or interference. This limit is further exacerbated by the need to provide spacing between radios on the same or adjacent channels in order to minimize the interference between the radios. In a wireless system this is typically handled through managing the reuse of spectrum between radios infrastructure devices (RID) within the desired coverage area. This limitation of available spectrum along with the need to physically separate the radios on the same or adjacent channels usually require a large number of diverse locations to be deployed within a WLAN to ensure capacity is available for the desired applications.

For the above mentioned reasons a WLAN usually requires a number of RIDs at geographically separate locations to cover the intended area, and as the coverage area is increased this causes a corresponding exponential increase in RIDs. This is one of the major drivers in the exponential increase in complexity of a WLAN as more area is covered.

In order to effectively handle the complexity of the WLANs many in the industry have begun to allow these devices to self configure, register on the network, use wireless as a backhaul method for RID, and determines the most efficient path to route messages. This type of networking is usually referred to as a ‘Mesh’ networking. Mesh networking can allow a network administrator to easily add a device to the network with little or no programming. Once a Mesh device is added to the network it usually registers on the network, automatically configures itself, and works out the most efficient method of routing messages using preprogrammed rules. Typically a mesh network is much easier to administer and will self-heal in the event of failure(s). This type of networking removes a great deal of complexity from the process of building and administering a WLAN network.

While Mesh networking allows a device to be easily added to a WLAN network, there is still the problem of providing backhaul and power for a RID. The backhaul issue has been addressed by the others in the industry by using wireless to backhaul the signals to the wired network; however, this can have an unintended consequence of actually increasing the cost and difficulty of installing a RID into a WLAN. When a non-mesh network device is installed, it usually requires both a power and data connection—usually Ethernet. Traditionally, this has required the installation of both a power and a data cable to enable full functionality; however, this problem has been addressed by the provision of power over Ethernet (PoE) that permits both low voltage power as well as data to be carried over a traditional Ethernet cable. Due to the equipment required to inject and remove the power from the Ethernet cable, this type of installation is typically more expensive than a straight Ethernet installation; however, in most cases the PoE is more cost efficient than installing both an Ethernet connection and a power line or even a power line alone.

Installing a power circuit alone for an application, such as wireless nodes in an enterprise or commercial space, can require:

Installation by a qualified electrician

Special Pentium rated electrical cable

Secure mounting to existing structures

Unique dedicated electrical circuit running back to the electrical closet.

Since PoE is a lower voltage and typically does not draw a high electrical current, most building codes treat these cables in the same manner as standard Ethernet cable. This greatly reduces the cost and complexity of supplying power to a WLAN device.

Usually a mesh type wireless network utilizes a wireless link to establish the backhaul between the nodes in the network. While the mesh-network eliminates the need for the hardwired data connection, it often requires a power circuit installed by an electrician. As stated above, the requirement to utilize a qualified electrician, as well as the increased cost of supplies can cause the installation of a dedicated power line in place of PoE to be substantially more expensive. These costs can increase the overall cost of installing a wireless network when using wireless backhaul.

To avoid this problem of supplying power it is possible to mount and power a WLAN device by utilize the connection between an electric discharge-lamp (which have been known to the art for some years, such lamps hereinafter referred to generally as fluorescent lamps) and the lighting fixture. When using a fluorescent lamp to power a RID in conjunction with the Mesh networking techniques allow a RID to be easily and quickly installed into a WLAN. These disclosures and techniques also allow a RID to be easily moved between locations in a WLAN.

One problem of being able to power the RIDs from a fluorescent lamp is the variation of the power supply (ballast) of the fluorescent lamps. Many of the older style fluorescent lamps are powered by what is referred to in the art as ‘core and coil’ ballast. The output frequency used to drive the fluorescent lamp of a core and coil ballast is usually in the range of 60 cycles per second (cps). This significantly differs from the frequency output of what is known in the art as an ‘electronic’ or ‘solid state’ ballast which typically operates with a frequency output in the range of 20,000 cps to as much as 40,000 cps. It is important to note that due to the large variation in operating frequency it makes it impractical to utilize a single transformer to derive direct current (DC) power from a core and coil ballast and electronic or solid state ballast. While it may be possible to utilize the same transformer the heat generated by the transformer in the different modes can limit the functionality, increase the power requirements, or limit the expected life span of the components. It is therefore desirable to have a common power supply that works effectively across the most common output frequencies and voltages of the lamp supply of most fluorescent ballast.

This dual frequency functionality can be desirable even for a power supply that is designed to operate with only a single type of frequency input. Since, in many cases, the connecting pins of a fluorescent lamp are the same for core and coil ballast as well as electronic ballast, a lamp intended to be used with one type of ballast can be installed into a fixture that currently contains the incorrect style of ballast. Since the user may not know which type of ballast their lighting is using, it is desirable to have a power supply capable of accepting multiple different inputs.

Yet another problem with drawing power from the lamp supply side of the fluorescent light is the introduction onto the power line of the noise generated by the ballast as well as the noise from excitation of the fluorescent lamp itself. This noise, when coupled on the DC output side of the power supply, can cause problems with radio and controller circuitry of the RID. It is therefore desirable to provide the RID with an extremely clean power supply in order to ensure optimal operations of the RID. Normal power supplies usually deal with a relatively clean power source that have acceptable levels of noise in the circuits. In a fluorescent lamp environment, extreme levels of noise are encountered from both the proper operations of the fluorescent ballast and from the exciters usually located on the ends of the fluorescent lamp itself. Although the noise of an individual model of ballast and bulb combination can be characterized, the operating frequency, construction, and material used in the ballast can radically alter the nature and amount of the noise present in the circuit. The exciters of the different style fluorescent lamps can also have a sever impact on the noise levels present in a power circuit used to draw power from the lamp supply side of a fluorescent ballast. While this noise is not a concern in the proper operations of the fluorescent lamp, it can cause a RID or other electronic equipment to fail to operate or to operate in a reduced manner. It is therefore desirable to have a power supply that derives its source from the fluorescent lamp side of a fluorescent ballast and provides a clean power signal to the RID or electronic device.

A further problem with drawing power from a fluorescent ballast intended primarily to provide power to the fluorescent lamp is accommodating the differing startup modes of different styles of fluorescent lamps. In order to start an electric arc between the electrodes in a fluorescent lamp, the voltage must be extremely high; however, the electrical resistance drops dramatically once the mercury vaporizes, creating a need for a device to regulate the input voltage. This is a primary function of the ballast.

Early style fluorescent lights had a small device called a “manual starter” which produced the voltage required to warm up the electrodes to start the lamp. Some starters were an extra position on the power switch. On these style switches one depressed the start button for a few seconds and watched the electrodes heat up. As the technology progressed this function was incorporated into the core and coil (C&C) ballast. Most C&C style fluorescent lamps found in business or commercial environments use what is termed in the art as a rapid start system. In this style of fluorescent lamp the ballast constantly channels current through both electrodes on the individual ends of the fluorescent lamp. This current flow is configured so that there is a charge difference between the two electrodes, establishing a voltage across the tube. When the fluorescent light is turned on, both electrode filaments heat up very quickly, boiling off electrons, which ionize the gas in the tube. Once the gas is ionized, the voltage difference between the electrodes establishes an electrical arc. The flowing charged particles excite the mercury atoms, triggering the lamp to ignite.

The electronic ballasts typically use a technique referred to in the art as instant-start. Instant-start ballast typically pass a very high voltage across the fluorescent lamp. This high voltage creates a corona discharge. Essentially, an excess of electrons on the electrode surface forces some electrons into the gas. These free electrons ionize the gas, and almost instantly the voltage difference between the electrodes establishes an electrical arc. The start-up voltage for instant start ballast often exceeds 1000 Volts while the operating voltage of the lamp is typically between 90 and 130 Volts.

As one skilled in the art can determine these differing techniques require a unique power supply to be able to handle the different startup sequences and voltages. It is therefore desirable for a power supply designed to operate from the lamp current from multiple different styles of fluorescent ballast to be capable of accommodating all of the start-up sequences and voltages of the most popular forms of fluorescent lighting styles.

It is further desirable for the power supply to only draw as much power as is minimally needed to power an RID. This will provide as much current as possible to the lamp and will allow the fluorescent lamp to continue to provide much of the intended illumination as possible.

It is still further desirable to allow a power supply designed to accept a single frequency input to illuminate a warning lamp or some type of signal to the user to indicate when the power supply is installed on the incorrect frequency of power. This can be used to notify the user why the power supply fails to operate properly when installed with the improper ballast.

It is desirable for the power supply to be as efficient as possible for another reason. In most cases, inefficiencies in a power supply are usually turned into heat. Fluorescent lamps are known to provide lower illumination as the temperature exceeds the designed operating range of the lamp. Therefore a power supply operating in a fluorescent light fixture should be as efficient as possible in order to minimize the heat impact on the lamp and to ensure the illumination provided by the lamp is not further negatively impacted.

### SUMMARY OF THE INVENTION

The present invention solves the problems of the prior art by providing methods and apparatus of a power supply to draw power from the lamp supply side of a fluorescent lamp ballast and to provide a power supply to an electronic device. This power supply is unique from other power supplies know in the art in the below mentioned manner.

In order to deal with significantly differing input frequencies the preferred implementation of the power supply will utilize multiple transformers. To achieve the desired application of drawing power from the lamp supply side of a ballast designed for a fluorescent lamp, two transformers connected in series are used. These two transformers will be constructed of such a material and with differing construction to allow each transformer to be designed to work at differing input frequencies. For this discussion we will refer to these transformers as the first and second transformers. It is noted that this naming convention is not intended to direct in what sequence the transformer should be configured. Those skilled in the art can recognize how these transformers may be wired differently to achieve the intended objectives of this disclosure. For this disclosure, the first transformer in the series will be the highest frequency transformer and the last transformer will be the lowest frequency transformer.

When a low frequency power source is applied to the input of the series of transformers the high-frequency transformer will be designed of a material, such as powdered iron, so it will be ineffective at low frequencies and the core of the transformer will not pass significant amounts of energy to its secondary winding. When this occurs the resistance of the primary winding will be the only significant impact onto the circuit. In this scenario the low-frequency transformer will become active and will act to supply the power to the RID or other electronic device.

When a high frequency power source is applied to the input of the series of transformers the low-frequency transformer will be designed of a material, such as silicon steel, that is ineffective at high frequencies. This will result in core saturation of the low-frequency transformer and the low-frequency transformer will not pass significant energy to its secondary winding. When this occurs the resistance of the primary winding will be the only significant impact onto the circuit. In this scenario the high-frequency transformer will become active and will act to supply the power to the RID or other electronic device

When receiving a low frequency power source a capacitor placed across the primary windings of the low-frequency transformer can act as a power factor correction device and will compensate for the resistance of the high-frequency transformer and improve the efficiency and operation of low-frequency transformer. When receiving a high frequency power source, the same capacitor across the primary windings of the low-frequency transformer will act as a bypass device and shunt the majority of the power to the high-frequency transformer. This will allow a single power supply to efficiently and effectively supply power from either a high frequency or a low frequency power source.

By using this disclosure one skilled in the art can determine how to utilize this transformer configuration for power supplies and other such devices where the input frequency available to said transformer(s) may vary from application to application, and where said transformer(s) function in a useful and satisfactory manner over a frequency range of fifty (50) cycles per second to as much as one hundred thousand (100,000) cycles per second or more. The inclusion of the preferred implementation is not intended to limit or restrict this transformer to only be utilized for a RID. The preferred implementation is merely to illustrate how this novel form of power supply can be utilized as a useful item in provision of wireless local area networking.

Yet another concern when constructing a power supply to operate off of the lamp supply of a fluorescent ballast is often the pin connectors for the fluorescent lamp are approximately the same for different frequency of lamps. Manufacturers have even made it possible for the incorrect style of lamp to function in a fluorescent lighting fixture; albeit at a much lower efficiency and illumination. Also, in many cases, a single frequency supply power supply drawing from a fluorescent lamp may be desirable. For example, due to government regulations and efficiencies the electronic style of ballast are becoming the predominate ballast used in enterprise spaces. Since the 60 cps power supplied by the core and coil ballast would require much larger and often more expensive components, it may prove desirable to produce a power supply capable of working with the electronic ballast. If an electronic ballast only power supply was produced it would still be desirable to allow this power supply to pull a limited amount of power from a 60 cps source to issue a warning to the user that it was installed into a fluorescent light fixture with the incorrect style of ballast. There are a number of methods to provide this functionality; however, the preferred implementation uses a simple capacitor network as described in the drawings.

A further problem with drawing power from a ballast intended primarily to provide power to the fluorescent lamp is accommodating the differing startup modes of different styles of fluorescent lamps. In order to start an electric arc between the electrodes in a fluorescent lamp, the voltage must be extremely high; however, the electrical resistance drops dramatically once the mercury vaporizes, creating a need for a device to regulate the input voltage. A power supply constructed to work with the lamp supply of a fluorescent light must be constructed with an over voltage circuit and possibly a delay in start up to deal with this potentially high voltage. The power supply also must be constructed in such a manner to detect and deal with a over voltage during normal operations.

As stated earlier the start up of the different styles of fluorescent ballast/lamps can be significantly different and a power supply constructed to operate with fluorescent lamps should take this into account. These differing techniques require a unique power supply to be able to handle the different startup sequences and Voltages. It is therefore desirable for a power supply designed to operate from the lamp current from multiple different styles of fluorescent ballast to be capable of accommodating most of the start-up sequences and voltages of the most popular forms of fluorescent lighting styles.

One skilled in the art, utilizing the information in this disclosure, can also determine how to construct the above mentioned transformers out of differing materials to achieve the goals of the invention stated herein. It is also possible for one skilled in the art using portions of the stated invention to build a dual frequency power supply that contains electronic means of sensing the input frequency and switching the power input to the correct transformer(s) or providing a manual method to switch a power supply between transformers. It is the intention of this disclosure to include all of these methods of provision of power for an RID or other device within the novel art disclosed herein.

These and other aspects, features and embodiments of the present invention will become apparent to those skilled in the art upon consideration of the following detailed description of illustrated embodiments exemplifying the best mode for carrying out the invention as presently perceived.

### BRIEF DESCRIPTION OF THE DRAWINGS

FIG. 1—Dual Frequency Power Supply Transformer Configuration

FIG. 2—A Dual Frequency Power Supply with an Electronic Switching Method

FIG. 3—Dual Frequency Power Supply with a Manual Switching Method

FIG. 4—Dual Frequency Regulated Power Supply with Startup Delay

FIG. 5—Incorrect Power Supply Indicator Circuit

FIG. 6—Flow Diagram for Dual Frequency Power Supply

FIG. 7—Over Voltage Detect and On Delay Circuit

FIG. 8—Operating Environment for Dual Frequency Power Supply

### DETAILED DESCRIPTION OF EXEMPLARY EMBODIMENTS

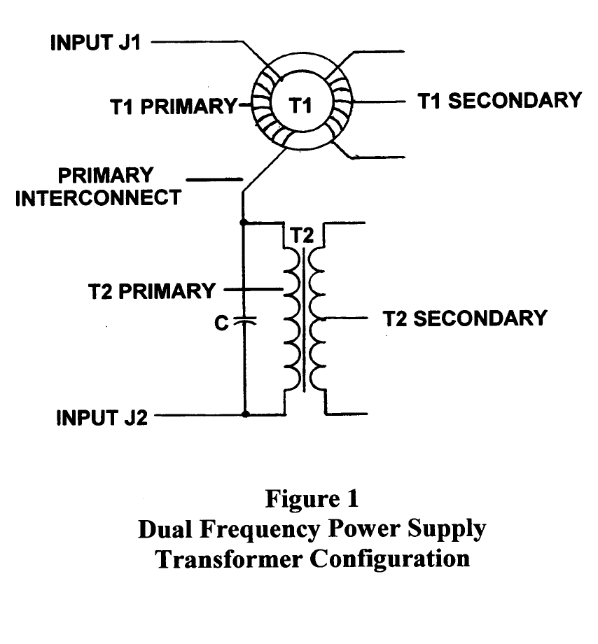

Referring to FIG. 1 In the operation of a Dual Frequency transformer(s) described herein, the basic function of each of the transformer(s) utilized is assumed to be of common knowledge to any person practiced in the art, and it shall be the unique combination of these conventional transformer(s) that will be described in detail below.

Transformer One (T1), as indicated in FIG. 1, shall represent a High Frequency transformer having a core material that is powdered iron or other such material that would operate efficiently in a High Frequency application. The type of material chosen would reflect the specific requirements for both power and frequency.

Transformer Two (T2), as indicated in FIG. 1, shall represent a Low Frequency transformer having a core material this is silicon steel or other such material that would operate efficiently in a Low Frequency application. The type of material chosen would reflect the specific requirements for both power and frequency.

By the inter-connection of T1 and T2 primaries in a series configuration (as depicted in FIG. 1), and with each transformer designed to operate at a desired but different frequency, power or Mains voltage is applied to the remaining input connections as indicated by INPUT J1 and INPUT J2. For purposes of discussion, transformer T1 is designed to operate at a higher frequency than transformer T2, and has been designed to operate at a lower frequency.

With Low Frequency Mains applied to INPUT J1 and INPUT J2, transformer T2 will become operational due to the fact that transformer T1 is constructed of a powdered iron or other such material, which shall be ineffective at Low Frequencies. As the core of transformer T1 fails to pass energy to its secondary, and the only energy loss incurred by transformer T1 is the DC resistance of the primary winding, and transformer T2 functions as designed, providing an output voltage at the Secondary winding. It is understood that the energy losses realized by the DC resistance in transformer T1 primary may be compensated for in the design of transformer T2 primary. In the case of Low Frequency operation, capacitor ‘C’ serves as a power factor correction device, dramatically improving the efficiency and operation of the transformer T2.

With High Frequency Mains applied to INPUT J1 and INPUT J2, transformer T1 will become operational due to the fact that transformer T2 is constructed of a silicon steel or other such material, which shall be ineffective at High Frequencies. This condition is typically referred to as Core Saturation, and transformer T2 fails to pass energy to it's secondary, and again, the only energy loss incurred by transformer T2 is the DC resistance of the Primary winding, and transformer T1 functions as designed, providing an output voltage at the Secondary winding. It is also understood that the energy losses realized by the DC resistance of transformer T2 primary may be compensated for in the design of transformer T1 primary. In the case of High Frequency operation, capacitor ‘C’ serves as a by-pass device, shunting the majority of High Frequency signal through ‘C’, and reducing the net energy loss seen at primary of transformer T2.

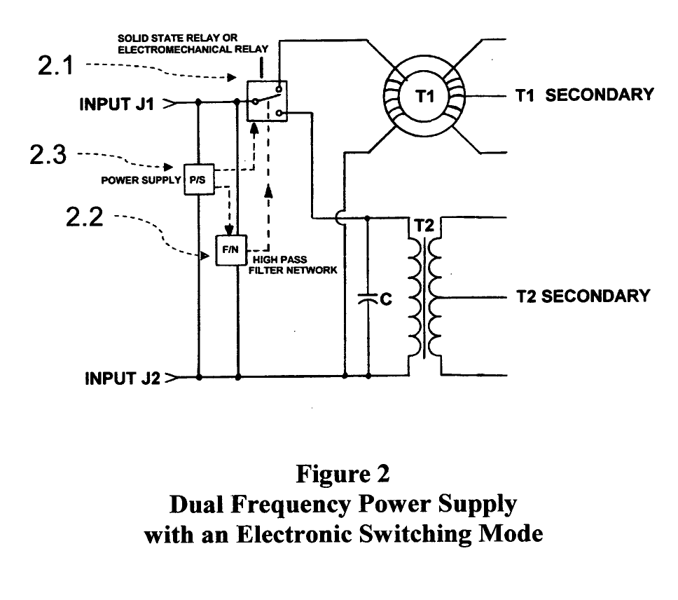

FIG. 2 illustrates a dual frequency power supply with an electronic switching method. This alternative form to achieve a similar functionality allows a power supply with two transformers to enable it to work effectively across multiple frequencies to be controlled by a solid state or electro mechanical relay 2.1. In order for this relay to function properly it requires a power supply 2.3 to power the relay and a method of sensing which power supply should be engaged. This sensing method is shown as a high pass filter network 2.2. One skilled in the art, using this disclosure, will be able to determine other methods of selecting the correct power supply.

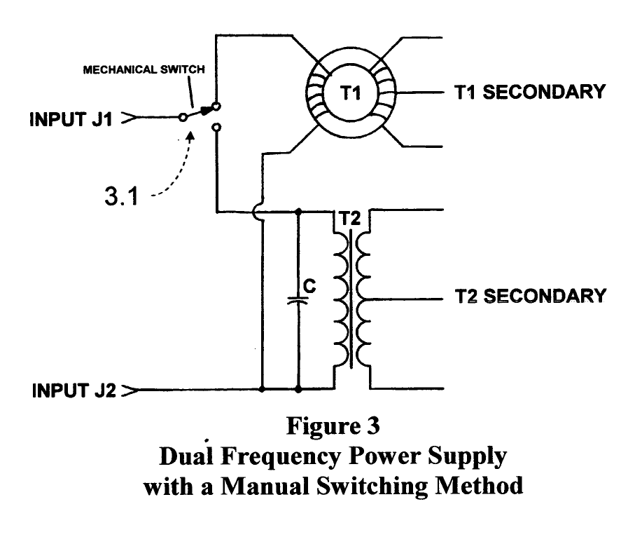

FIG. 3 illustrates a dual frequency power supply with a mechanical switching method. This power supply would require a human to determine which type of frequency input is required and to manually select the appropriate setting utilizing the mechanical switch 3.1. In order to somewhat automate the mechanical switch selection one could allow the mechanical switch 3.1 to be automatically selected by physical method that determined the form of the fluorescent lamp and automatically placed the mechanical switch into the correct position for proper operations. Since generally high frequency fluorescent lamps are 1 inch in diameter and low frequency florescent lamps are 1.5 inches in diameter one can see how this manual selection method can be achieved by sensing the size of the lamp supporting the power supply.

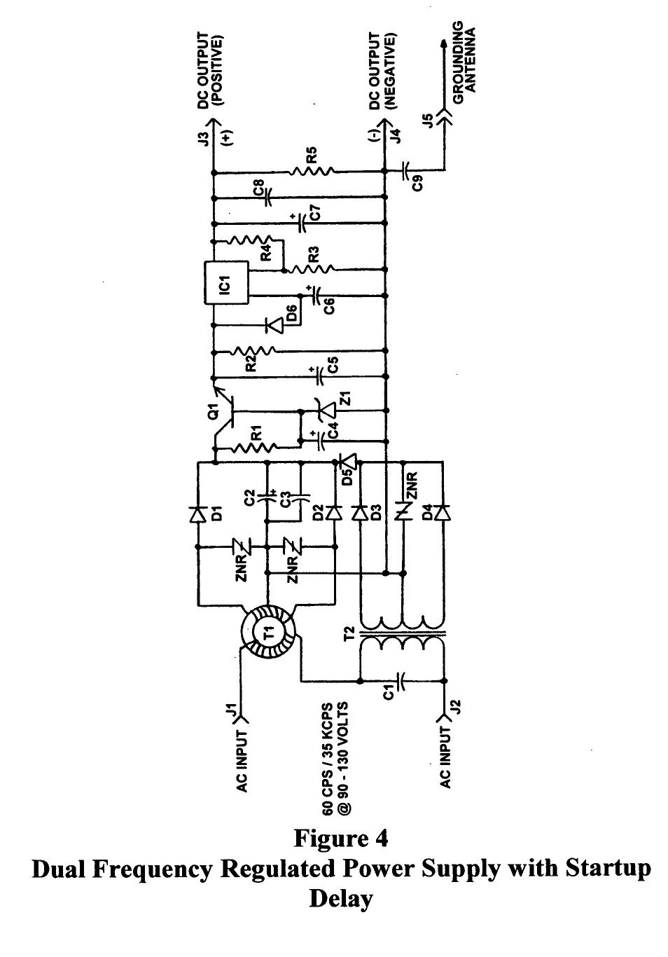

Referring to FIG. 4, the function of transformer(s) T1 and T2 and associated component ‘C’ are described in detail in U.S. Provisional Patent Application Ser. No. 60/546,468 entitled “METHODS AND APPARATUS FOR CONSTRUCTING A POWER SUPPLY CAPABLE OF DUAL FREQUENCY INPUT”, filed Feb. 19, 2004; and U.S. Provisional Patent Application Ser. No. 60/547,574 entitled—METHODS AND APPARATUS FOR CONSTRUCTING A DUAL FREQUENCY REGULATED POWER SUPPLY filed Feb. 24, 2003”, and shall be incorporated by reference. Only those components connected to the Secondary of transformer T1 and T2 shall be discussed.

The secondary winding of transformer T1 (high frequency transformer) in this application is center tapped to achieve a full wave rectification of the output voltage with the minimum of components. The rectification is provided by two (2) high efficiency diodes D1 and D2. The resulting DC output is further filtered and smoothed by filter capacitor C2. Capacitor C3 is provided within the same circuit and serves as a spike or high frequency filter. ZNR's or voltage dependant resistors are provided between the secondary turns and the center tap of the transformer to limit the secondary output voltages to a safe level. It must be understood that the open circuit voltages available at the output leads of solid state or electric fluorescent ballast may be in excess of one thousand (1,000) volts. This high voltage is required to ‘light’ or ionize the gases within the lamp. Once the lamp gasses are ionized, this voltage drops into a range of between ninety (90) volts and one hundred thirty (130) volts, the level at which the power supply is intended to operate. The ZNR's prevent unnecessary damage to the regulator components during the ‘Start’ cycle of the fluorescent lamp and are electrically nonexistence in the circuit during normal lamp operation.

The secondary winding of transformer T2 (low frequency transformer) in this application is center tapped as well. Again, rectification of the AC current to DC current is accomplished by two (2) rectifier diodes D3 and D4. Again, a ZNR is utilized to prevent excessive output voltages at the secondary of transformer T2. The DC output of transformer T2 is not filtered or smoothed, but rather directed through a high efficiency diode D5, allowing capacitor C2 and C3 to smooth and filter as described above. Diode D5 is used as a blocking diode, which isolates transformer T2 from the circuit during high frequency operation, but allows current to flow from transformer T2 to remaining circuit during low frequency operation.

DC voltages derived from rectifier diodes D1 thru D5 and filter capacitors C2 and C3 are imposed upon the Collector of the pre-regulator transistor Q1. This voltage is passed through Q1 to the Emitter as a result of resistor R1. R1 serves to forward bias the transistor, or place it in a conductive or ‘On’ state. It must be noted that Q1 serves two purposes. Firstly, Q1 serves as an electronic filter, derived from the gain or Beta of the transistor, which multiplies the capacitance value of capacitor C4. The net result is exceptionally high filtering or smoothing function. This permits a relatively small capacitor value to be multiplied by the transistor Beta, resulting is a high value capacitor equivalent. The second function of transistor Q1 is that of a series pass voltage regulator. As described earlier, resistor R1 forces Q1 into conduction. As the input voltage at the junction of Q1 collector and bias resistor R1 increases, so too does the voltage imposed across Zener Diode Z1. As this voltage approaches the Zener voltage rating, the Zener becomes conductive, forcing the voltage at the emitter or output of transistor Q1 to nearly match that of the Zener Z1 rating. In this particular application, Q1 is considered to be a Pre-Regulator. The purpose of the pre-regulator is to prevent any voltages seen by the circuit from exceeding the voltage rating of Zener Z1. The voltage rating of Z1 must be below that maximum input voltage rating of Post Voltage Regulator IC1 in order to prevent damage during fluorescent lamp start-up. The output of pre-regulator Q1 is further filtered or smoothed by capacitor C5.

The output voltage of the pre-regulator as seen by transistor Q1 Emitter and positive terminal of capacitor C5 is connected to the input pin 1 of a precision Voltage Regulator IC1. Pin 2 of IC1 represents the positive (+) output of the regulator, and contains three additional elements. Capacitor C7 represents a filter intended to ‘snub’ or suppress low frequency noise that may be generated by any load applied to the output, whereas capacitor C8 represents a filter intended to ‘snub’ or suppress high frequency noise that may be generated by any load applied to the output. Resistor R5 provides a low level load on the output of the regulator in order to prevent ‘chatter’ or ‘hunting’ during No Load conditions.

Resistor R3 and R4 provide a voltage divider which permits the output of regulator IC1 to be raised above its intended design voltage by raising the Ground Pin 3 of IC1 a pre-determined amount. This is a common practice within the industry, where special output voltages are required and not available commercially.

Voltage regulator IC1 contains a ‘control’ or ON/OFF terminal represented by Pin 4. In such a regulator, if this ‘control’ pin is held high, or near its input voltage, the regulator functions as intended, with an output voltage at Pin 2. If the ‘control’ pin is held low, or near the supply Negative, the output is turned off and no voltage flows at Pin 2. By incorporating a capacitor C6 into the circuit, the ‘control’ pin is initially held low during the application of power, thus preventing an output at Pin 2 for such period of time as is required to charge capacitor C6. Increasing or decreasing the value of capacitor C6 may control the delay time before power is available at Pin 2 of IC1. This delay prevents any load from being applied to the power supply until after the fluorescent lamp or fixture has lighted. D6 serves to discharge capacitor C6 upon removal of power supply input voltages, resetting C6 to an uncharged or Negative potential.

Capacitor C9 serves to couple the Negative (−) output terminal of the power supply to earth or other suitable fixture grounding, further aiding in the reduction of noise potentially created by various loads at output terminals J3 and J4.

Although the present invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined by reference to the claims that follow.

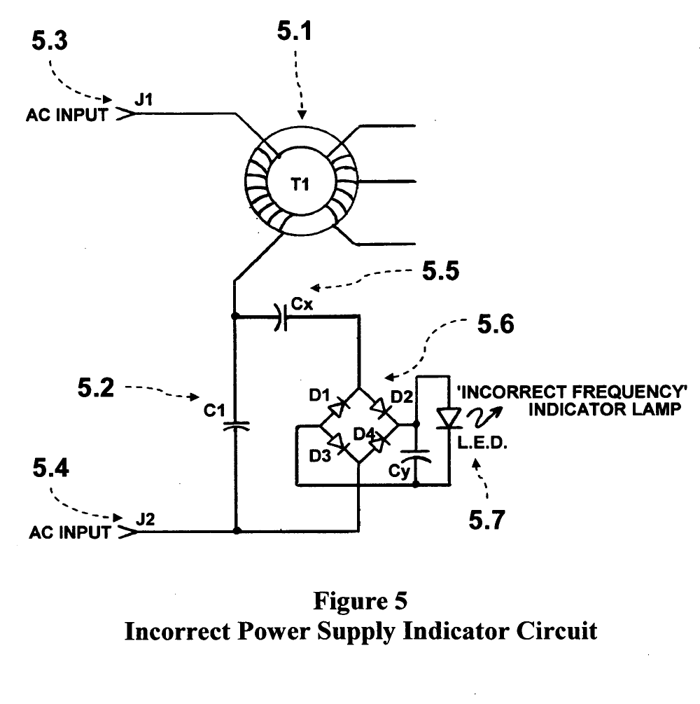

Referring now to FIG. 5, toroid transformer 5.1 operates at higher frequencies, between 30 and 35 kilocycles, typically found in newer electronic ballasts. Note that capacitor 5.2 is in series with one leg of the toroid transformer between AC INPUT terminals 5.3 and 5.4. Capacitor 5.2 serves two (2) purposes:

Capacitor 5.2 limits the available current to transformer 5.1 when improperly connected to a low frequency power source (60 Hz). This current limiting capability reduces unnecessary loading of a 60 Hz ballast and prevents possible damage to said ballast

During high frequency operation (30-35 KHz), capacitor 5.2 becomes highly conductive, with little energy loss, disabling the remainder of the indicator circuit

At 30-35 KHz, capacitor 5.2 imparts little energy on the indicator circuit comprised of 5.5, and circuit 5.6 comprised of D1-D4, Cy and LED. During application of 60 Hz, transformer 5.1 acts as short circuit (due to the limited number of turns on the primary), and is dependent on capacitor C1 to limit the energy consumed. With the application of 60 Hz to AC INPUTS 5.3 and 5.4, the majority of the voltage supplied by the 60 Hz ballast is observed across capacitor 5.2. The indicator circuit derives power via a second current limiting capacitor 5.5 and AC INPUT 5.4. This voltage is applied across input of rectifier bridge D1-D4. The resulting DC voltage is filtered by capacitor Cy and applied to light emitting diode (LED), providing the installer with an indication of ‘incorrect ballast condition’.

Any high frequency (30-35 KHz) applied to AC INPUT 5.3 and 5.4 is passed through capacitor 5.2 to toroid 5.1, with insufficient voltage across capacitor 5.2 to activate the remaining LED circuit.

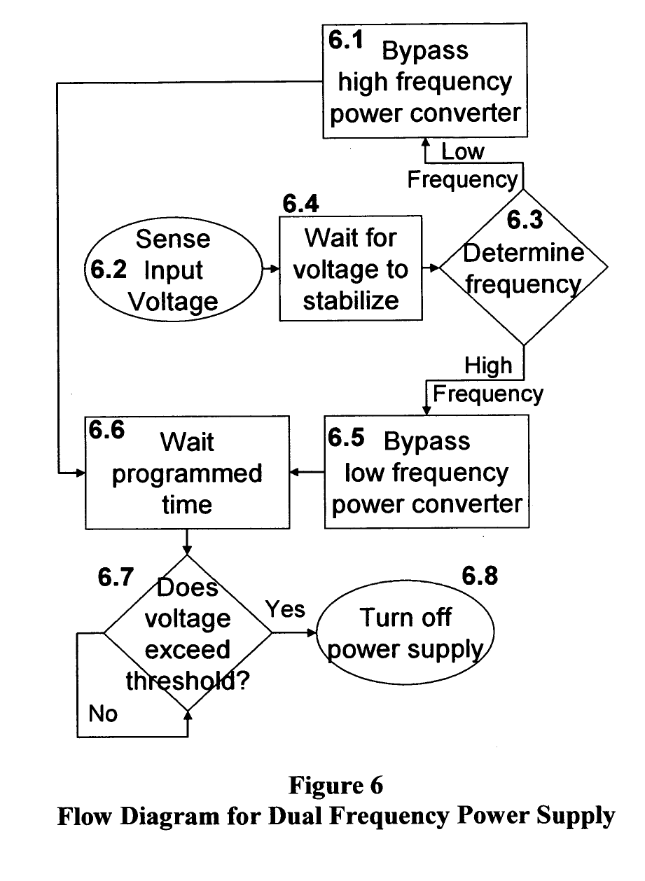

Referring now to FIG. 6, the flow diagram for the dual mode power supply, the power supply first senses input voltage 6.2. The power supply will then wait for the start up sequence for the fluorescent lamp to progress and the supply voltage to the power supply to stabilize 6.4. The power supply will then determine the frequency 6.3 of the supply voltage. If it senses a high frequency power source then the power supply bypasses the low frequency power converter 6.5 and if it senses a low frequency power source it bypasses the high frequency power source 6.1. Once the power supply determines the supply frequency 6.4 it then, optionally, waits another programmed period of time 6.6 to allow the fluorescent lamp to reach an operating temature. The power supply then monitors the input voltage to determine if the voltage goes out of the range identified as proper input for the power converters 6.7. If the voltage goes out of the predetermined range the power supply turns itself off 6.8 to prevent damage and the state diagram goes back to the beginning where the power supply was sensing input voltage 6.2. If the voltage does not go out of the predetermined range the power supply continues to operate and monitor the input voltage.

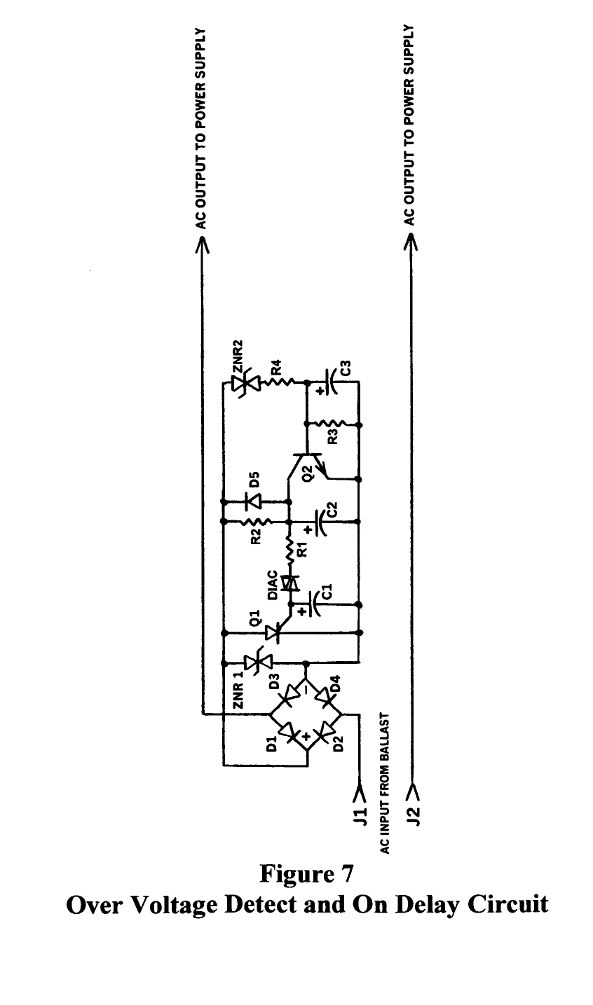

Referring now to FIG. 7, this represents a diagram of an Over-Voltage and On-Delay circuit. This circuit provides two basic functions: (1) The On-Delay portion of the circuit prevents AC voltages made available at the lamp contacts via inputs J1 and J2 from being transferred to the power supply transformer T1 primary for a predetermined period of time. This delay provides the lamp and ballast sufficient time to stabilize electrically and thermally, and (2) the Over-Voltage portion of the circuit prevents AC voltages made available at the lamp contacts via inputs J1 and J2 from being transferred to the power supply transformer T1 primary in the event that fluorescent lamp fails to ionize due to age or mechanical contact failure.

The Over-Voltage Detect and On-Delay circuit is comprised of three basic sections: (1) The AC controlling section being comprised of rectifier diodes D1-D4, ZNR1 and control Silicon Control Rectifier (SCR) Q1; (2) the Time Delay section being comprised of capacitor C1, Diac, R1, R2, C2 and D5; and the Over-Voltage Detect section being comprised of Q2, ZNR2 R3, R4 and C3

Upon normal power-up of fluorescent fixture with a normally functioning lamp, nominal lamp voltage is made available at input terminals J1 and J2. This voltage is impressed upon AC terminals of rectifier bridge D1-D4, providing an unfiltered DC voltage across SCR Q1 and voltage limiter ZNR1. This DC voltage is also applied to timing capacitor C2 via timing resistor R2. The DC voltage across capacitor C2 continues to increase until the threshold of Diac (aprox 32 volts) is achieved as supplied through current limiting resistor R1. As the break-over voltage of Diac is reached, the energy stored in timing capacitor C2 is discharged into holding capacitor C1 and Gate of SCR Q1, causing SCR Q1 into forward conduction. The resulting short circuit of output terminals of rectifier bridge D1-D4 allows AC voltage to pass directly through rectifier bridge to power supply transformer T1. The manipulation of timing resistor R2 and timing capacitor C2 values provide for a wide range of On-Delay delay options. ZNR1 is a voltage dependent resistor that limits the maximum voltage that may be impressed upon SCR Q1.

Steering diode D5 ensures that any remaining energy stored in timing capacitor C2 is discharged upon removal of power from rectifier bridge D1-D4.

It is understood that when a DC voltage is applied across an SCR, and once the SCR has been triggered (turned on), it will remain in a conductive state until said DC voltage has been removed, regardless of the gate trigger voltage potential as seen at junction of capacitor C1 and Diac.

Upon application of ballast Open Circuit Voltage (OCV) to input terminals J1 and J2 (failed lamp), the voltage present at the output terminals of rectifier bridge D1-D4 exceeds the break-over rating of voltage dependent resistor ZNR2. As ZNR2 becomes conductive, a positive voltage is passed through current limiting resistor R4 to filter capacitor C3. The resulting voltage at C3 is sufficient to forward bias (turn on) NPN transistor Q2, which in turn prevents timing capacitor C2 from charging. As capacitor C2 is unable to charge, SCR Q1 remains in a non-conductive state, and the AC portion of rectifier bridge D1-D4 remains open, and no ballast voltage is made available to power supply transformer T1 primary. Resistor R3, in conjunction with resistor R4, serves as a voltage divider for the Base of transistor Q2, as well as a discharge path for capacitor C3 after ballast OCV has been removed.

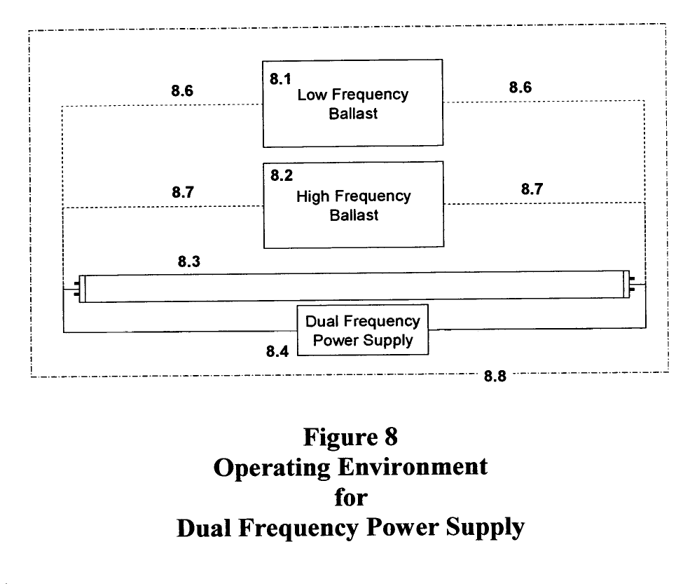

Referring now to FIG. 8. Alternatively, a low frequency ballast 8.1 can be connected to the fluorescent lamp 8.3 via the fluorescent light fixture's 8.8 wiring 8.6, or a high frequency ballast 8.2 can be connected to the fluorescent lamp 8.3 via the fluorescent light fixture's 8.8 wiring 8.7. It is understood that only one of these ballast (8.1 or 8.2) would be present in a normal lighting fixture and would power the fluorescent lamp 8.3 at any given time. The diagram illustrates these two ballast (8.1 and 8.2) to illustrate these options are available for powering fluorescent lamp 8.3.

The dual frequency power supply 8.4 can be optionally located in the fluorescent lighting fixture 8.8 or in near proximity to the fluorescent lighting fixture 8.8. The dual frequency power supply 8.4 connects to both ends of the fluorescent lamp and draws power from the ballast (8.1 or 8.2) powering the lamp 8.3. The lighting fixture 8.8 ballast (either 8.1 or 8.2) will supply power to both the dual frequency power supply 8.4 and the fluorescent lamp 8.3.

Based on the foregoing, it can be seen that the present invention provides various systems and method for deriving power from a dual frequency input. Many other modifications, features and embodiments of the present invention will become evident to those of skill in the art. It should also be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It will be understood that the invention is not restricted to the illustrated embodiments and that various other modifications can be made within the scope of the following claims.

1) A power supply apparatus capable of providing meaningful amounts of energy as derived from the lamp supply side of a fluorescent lighting power supply while still allowing said lamp power supply to provide enough power to drive the lamp.

2) The apparatus of claim 1 where the power supply consists of at least a first transformer designed primarily to operate with higher frequency power source and a second transformer designed primarily to operate with a lower frequency power source.

3) The apparatus of claim 2 where the two transformers are connected in series to allow a single power supply to feed both transformers without a separate switching mechanism.

4) The apparatus of claim 2 where a capacitor is placed across the input leads of at least one of the transformers to allow the power signals to bypass the transformer and power the other transformer.

5) The apparatus of claim 1 including one transformer designed to operate with the first power frequency and one capacitor designed to operate with the second power frequency.
The method of constructing a power supply capable of drawing meaningful levels of power from the lamp side of a fluorescent lighting ballast.

6) The method of claim 6 where the power supply is equipped with a start up over voltage detection circuit.

7) The method of claim 6 where the power supply is designed to operate with at least two input frequencies.

8) The method of claim 7 where the power supply is capable of sensing an over voltage current during normal operations and handling this current in a manner that does not damage the power supply.

9) A power supply apparatus with a delay startup routine and is capable of providing meaningful amounts of energy as derived from the output of a fluorescent lighting power supply.

10) The apparatus of claim 10 where the power supply includes a method of filtering noise from the power in order to provide a stable power source to a device.

11) The apparatus of claim 10 where the power supply includes at least a method to filter high frequency noise as well as low frequency noise.

12) A method of
sensing a circuit for the presence of an AC input current
detection of a drop in voltage
and then beginning the startup sequence for a power supply

13) The method of claim 13 where the sensing circuit is designed to work with lamp output of a fluorescent light power supply.

14) The method of claim 14 where a delay mechanism is introduced between sensing the drop in voltage and beginning the startup sequence for the power supply.

15) The method of claim 14 where the power supply is designed to function with at least two distinct frequency inputs

16) The method of claim 12 where the power supply includes at least an apparatus for filtering any noise present in the power input.

17) An apparatus consisting of
a sensing means capable of detecting the presence of electrical current
a power supply
a means of coupling the power supply to the lamp supply of a fluorescent ballast
a means of detecting the completion of the startup sequence of a fluorescent lamp
a means of delaying the start of the power supply until the fluorescent lamp startup is complete.

18) The apparatus of claim 18 where the apparatus is designed to function properly with at least two differing supply frequencies.

19) The apparatus of claim 19 including a means for filtering out the noise present on the input voltage for the apparatus.
